(19) United States
(12) Patent Application Publication
(10) Pub. No.: US 2026/0160067 A1
(43) Pub. Date: Jun. 11, 2026

(54) REFLECTIVE ROOFING GRANULES HAVING COATING INCLUDING A CRISTOBALITE COMPONENT AND PROCESSES FOR MAKING THE SAME

(71) Applicant: Covia Solutions LLC, Independence, OH (US)

(72) Inventor: Jason Lamb, Huntersville, NC (US)

(73) Assignee: Covia Solutions LLC, Independence, OH (US)

(21) Appl. No.: 18/974,249

(22) Filed: Dec. 9, 2024

(51) Int. Cl. E04D 1/00; C09D 1/00; C09D 7/61

(52) U.S. Cl. CPC E04D 1/00; C09D 1/00; C09D 7/61; E04D 2001/005

(57) ABSTRACT

A roofing granule includes a core and a coating on the core. The coating comprises at least 10 wt. % of a cristobalite component, titanium dioxide, clay, and a hardener. A weight ratio of the amount of cristobalite component to the amount of titanium dioxide in the coating is from about 1:1 to about 5:1. Accordingly, the roofing granule exhibits an improvement in L* value of at least 6% as compared to an L* value of the core alone and/or an improvement in solar reflectivity of at least 5% as compared to a solar reflectivity of the core alone.

### BACKGROUND

Mineral granules can help retain the integrity of roofing and other architectural products during exposure to an outdoor environment. Specifically, granules can protect and preserve the roofing and architectural products from wear and abrasion caused by rain, snow, ice and wind and from damage caused by solar ultraviolet radiation, and can also serve other purposes such as providing an aesthetic appeal to the roof and reflectance of solar energy and light. In some locations, building codes require roofs to have certain properties, such as a minimum solar reflectance. Mineral powders can be added to paints and surface coating materials to provide reflectance of light for enhanced visibility, for example, use as lane and road markings on pavement.

A variety of materials have been proposed to provide solar and light reflectance, although many of the materials do not satisfy other requirements for roofing and coating materials. Still other materials that have been proposed to provide reflectance are too costly for incorporation into roofing and other coating materials.

### SUMMARY

In aspects of the present disclosure, a roofing granule comprises a core and a coating on the core. The coating comprises at least 10 wt. % of a cristobalite component, titanium dioxide, clay, and a hardener. A weight ratio of the amount of the cristobalite component to the amount of titanium dioxide in the coating is from about 1:1 to about 5:1, and the roofing granule exhibits an improvement in L* value of at least 6% as compared to an L* value of the core alone.

In aspects, a roofing granule comprises the roofing granule of any of the previous aspects, wherein core comprises nepheline syenite.

In aspects, a roofing granule comprises the roofing granule of any of the previous aspects, wherein the coating comprises from about 10 wt. % to about 35 wt. % of the cristobalite component.

In aspects, a roofing granule comprises the roofing granule of any of the previous aspects, wherein the coating comprises from about 10 wt. % to about 35 wt. % titanium dioxide. In aspects, the titanium dioxide is pigmentary.

In aspects, a roofing granule comprises the roofing granule of any of the previous aspects, wherein the coating comprises from about 5 wt. % to about 20 wt. % kaolin clay.

In aspects, a roofing granule comprises the roofing granule of any of the previous aspects, wherein the hardener comprises sodium silicate.

In aspects, a roofing granule comprises the roofing granule of any of the previous aspects, wherein the roofing granule has an aspect ratio of from about 1:1 to about 1:1.4.

In aspects, a roofing granule comprises the roofing granule of any of the previous aspects, wherein the roofing granule exhibits an improvement in solar reflectivity of at least 5% as compared to the solar reflectivity of the core alone.

In aspects, a roofing granule comprises the roofing granule of any of the previous aspects, wherein the roofing granule has an average particle size of from about 0.45 mm to about 2.5 mm.

In various aspects disclosed herein, coating composition for a roofing granule comprises at least 10 wt. % of the cristobalite component, titanium dioxide, kaolin clay, and a hardener. A weight ratio of the amount of the cristobalite component to the amount of titanium dioxide in the coating is from about 1:1 to about 5:1, and when applied to a core comprising nepheline syenite and calcined to form a roofing granule, the resulting roofing granule exhibits an improvement in L* value of at least 6% as compared to an L* value of the core alone.

In aspects, a coating composition comprises the coating composition of any of the previous aspects, wherein the coating composition comprises from about 10 wt. % to about 35 wt. % of the cristobalite component.

In aspects, a coating composition comprises the coating composition of any of the previous aspects, wherein the coating composition comprises from about 10 wt. % to about 35 wt. % titanium dioxide.

In aspects, a coating composition comprises the coating composition of any of the previous aspects, wherein the titanium dioxide is pigmentary.

In aspects, a coating composition comprises the coating composition of any of the previous aspects, wherein the coating composition comprises from about 5 wt. % to about 20 wt. % kaolin clay.

In aspects, a coating composition comprises the coating composition of any of the previous aspects, wherein the hardener comprises sodium silicate.

### BRIEF DESCRIPTION OF THE DRAWINGS

FIG. 1 is a graph depicting the whiteness (L*, y-axis) as a function of the amount of the cristobalite component (grams; x-axis) for various coating compositions.

FIG. 2 is a graph depicting the solar reflectance (%, y-axis) as a function of the amount of the cristobalite component (grams; x-axis) for various coating compositions.

FIG. 3 is a graph depicting the abrasion resistance (wt. % fines created, y-axis) as a function of the amount of the cristobalite component (grams; x-axis) for various coating compositions.

### DETAILED DESCRIPTION

The present disclosure provides a granule including a core and a coating on the core that includes at least 10 wt. % of the cristobalite component, titanium dioxide, kaolin clay, and a hardener. The inclusion of the cristobalite component in the coating gives the granule an improved whiteness and relatively low cost.

The present disclosure also provides coating composition including at least 10 wt. % of the cristobalite component, titanium dioxide, kaolin clay, and a hardener. A weight ratio of the amount of the cristobalite component to the amount of titanium dioxide in the coating is from about 1:1 to about 5:1. When the coating composition is applied to a core formed from, for example, nepheline syenite and calcined to form a roofing granule, the resulting roofing granule exhibits an improvement in L* value of at least 6% as compared to an L* value of the core alone.

Unless otherwise indicated, all mesh sizes disclosed herein refer to mesh (U.S.).

Due to variations in feed materials and accuracy of measurement issues, it will be understood that “about” in connection with the above concentrations means that the above numbers have an accuracy of ±3 wt. %, more typically ±2 wt. %, ±1 wt. %. and even ±0.1 wt. % are also possible.

### Coating Compositions

In various aspects, a coating composition generally includes a cristobalite component, clay, titanium dioxide, and a hardener. The coating composition may be an aqueous solution (e.g., the composition may further include water). In various aspects, the aqueous coating composition is applied to a core material then dried and calcined to form a coated granule.

The cristobalite component in the coating composition generally imparts solar reflectivity and whiteness to the coating formed by the coating composition. As used herein, a “cristobalite component” refers to a silica polymorph mixture containing a minimum of 51% cristobalite and preferably greater than or equal to 65% cristobalite. In aspects, the cristobalite components contains from about 65% to about 80% cristobalite. The remainder of the silica polymorph mixture includes quartz, tridymite, and amorphous silica. The cristobalite component included in the coating composition has a d50 (median) particle size of 1-30 μm, including d50 particle size ranging from about 1 to about 25 μm, including from about 1 to about 20 μm, from about 1 to about 15 μm, from about 1 to about 12 μm, from about 1 to about 10 μm, from about 1 to about 8 μm, from about 1 to about 5 μm, from about 2 to about 30 μm, from about 2 to about 25 μm, from about 2 to about 20 μm, from about 2 to about 15 μm, from about 2 to about 12 μm, from about 2 to about 10 μm, from about 2 to about 8 μm, from about 2 to about 5 μm, from about 3 to about 30 μm, from about 3 to about 25 μm, from about 3 to about 20 μm, from about 3 to about 15 μm, from about 3 to about 12 μm, from about 3 to about 10 μm, from about 3 to about 8 μm, and from about 3 to about 5 μm, including any and all ranges and subranges therein. The cristobalite component of the present disclosure may have a d99 (top size) particle size of about 80 μm or less, including about 75 μm, about 70 μm, about 65 μm, about 60 μm, about 55 μm, about 50 μm, about 45 μm, about 40 μm, about 35 μm, about 30 μm, or about 25 μm, including any and all ranges and subranges therein. In certain aspects, the cristobalite component may have a d99 particle size of about 76 μm or about 51 μm. Note, any d99 particle size disclosed herein for the cristobalite component may be combined with any d50 particle size range disclosed herein for the cristobalite component. Unless otherwise indicated here, particle size is determined by laser diffraction detailed in the working examples.

The cristobalite component of the present disclosure has a specific gravity (ratio of density of substance to density of water at 4° C.) ranging from about 2.25 g/cc to about 2.45 g/cc, including from about 2.28 g/cc to about 2.45 g/cc, from about 2.30 g/cc to about 2.45 g/cc, from about 2.32 g/cc to about 2.45 g/cc, from about 2.35 g/cc to about 2.45 g/cc, from about 2.38 g/cc to about 2.45 g/cc, from about 2.40 g/cc to about 2.45 g/cc, from about 2.42 g/cc to about 2.45 g/cc, from about 2.28 g/cc to about 2.42 g/cc, from about 2.30 g/cc to about 2.42 g/cc, from about 2.32 g/cc to about 2.42 g/cc, from about 2.35 g/cc to about 2.42 g/cc, from about 2.38 g/cc to about 2.42 g/cc, from about 2.40 g/cc to about 2.42 g/cc, from about 2.28 g/cc to about 2.40 g/cc, from about 2.30 g/cc to about 2.40 g/cc, from about 2.32 g/cc to about 2.40 g/cc, from about 2.35 g/cc to about 2.40 g/cc, from about 2.38 g/cc to about 2.40 g/cc, from about 2.28 g/cc to about 2.38 g/cc, from about 2.30 g/cc to about 2.38 g/cc, from about 2.32 g/cc to about 2.38 g/cc, from about 2.35 g/cc to about 2.38 g/cc, from about 2.28 g/cc to about 2.36 g/cc, from about 2.30 g/cc to about 2.36 g/cc, from about 2.32 g/cc to about 2.36 g/cc, from about 2.35 g/cc to about 2.36 g/cc, from about 2.28 g/cc to about 2.34 g/cc, from about 2.30 g/cc to about 2.34 g/cc, or from about 2.32 g/cc to about 2.34 g/cc, including any and all ranges and subranges therein.

The cristobalite component of the present disclosure has particularly white color characteristics. With a d50 particle size of from about 1 to about 30 μm and a d99 particle size of about 76 μm, the cristobalite component of the present disclosure exhibits a L* value in the CIELAB color space of at least about 96.5, including at least about 97 or at least about 97.5, such as from about 96.5 to about 100, from about 97 to about 100, from about 97.5 to about 100, from about 96.5 to about 99.9, from about 97 to about 99.9, from about 97.5 to about 99.9, from about 96.5 to about 99.75, from about 97 to about 99.75, from about 97.5 to about 99.75, from about 96.5 to about 99.5, from about 97 to about 99.5, from about 97.5 to about 99.5, from about 96.5 to about 99, from about 97 to about 99, from about 97.5 to about 99, from about 96.5 to about 98.5, from about 97 to about 98.5, from about 97.5 to about 98.5, from about 96.5 to about 98, from about 97 to about 98, or from about 97.5 to about 98, including any and all ranges and subranges therein.

With a d50 particle size of from about 1 μm to about 30 μm and a d99 particle of about 76 μm, the cristobalite component of the present disclosure exhibits an a* value in the CIELAB color space of less than or equal to about 0, including less than about 0, such as from about −0.5 to about 0, from about −0.5 to about −0.001, from about −0.5 to about −0.01, from about −0.5 to about −0.02, from about −0.5 to about −0.05, from about −0.5 to about −0.1, from about −0.5 to about −0.15, from about −0.5 to about −0.2, from about −0.5 to about −0.25, from about −0.5 to about −0.3, from about −0.5 to about −0.35, from about −0.5 to about −0.4, from about −0.5 to about −0.45, from about −0.4 to about −0.001, from about −0.4 to about −0.01, from about −0.4 to about −0.02, from about −0.4 to about −0.05, from about −0.4 to about −0.1, from about −0.4 to about −0.15, from about −0.4 to about −0.2, from about −0.4 to about −0.25, from about −0.4 to about −0.3, from about −0.4 to about −0.35, from about −0.3 to about −0.001, from about −0.3 to about −0.01, from about −0.3 to about −0.02, from about −0.3 to about −0.05, from about −0.3 to about −0.1, from about −0.3 to about −0.15, from about −0.3 to about −0.2, from about −0.3 to about −0.25, from about −0.25 to about −0.001, from about −0.25 to about −0.01, from about −0.25 to about −0.02, from about −0.25 to about −0.05, from about −0.25 to about −0.1, from about −0.25 to about −0.15, from about −0.25 to about −0.2, from about −0.2 to −0.001, from about −0.2 to −0.01, from about −0.2 to −0.02, from about −0.2 to −0.05, from about −0.2 to about −0.1, from about −0.2 to about −0.15, from about −0.16 to about −0.001, from about −0.16 to about −0.01, from about −0.16 to about −0.02, from about −0.16 to about −0.05, from about −0.16 to about −0.1, from about −0.12 to about −0.001, from about −0.12 to about −0.01, from about −0.12 to about −0.02, from about −0.12 to about −0.05, or from about −0.12 to about −0.1, including any and all ranges and subranges therein.

With a d50 particle size of from about 1 μm to about 30 μm and a d99 particle of about 76 μm, the cristobalite component of the present disclosure exhibits a b* value in the CIELAB color space of up to about 2, such as from about 0 to about 2, from about 0 to about 1.75, from about 0 to about 1.5, from about 0 to about 1.25, from about 0 to about 1, from about 0 to about 0.75, from about 0 to about 0.55, from about 0 to about 0.5, from about 0.05 to about 2, from about 0.05 to about 1.75, from about 0.05 to about 1.5, from about 0.05 to about 1.25, from about 0.05 to about 1, from about 0.05 to about 0.75, from about 0.05 to about 0.55, from about 0.05 to about 0.5, from about 0.1 to about 2, from about 0.1 to about 1.75, from about 0.1 to about 1.5, from about 0.1 to about 1.25, from about 0.1 to about 1, from about 0.1 to about 0.75, from about 0.1 to about 0.55, from about 0.1 to about 0.5, from about 0.15 to about 2, from about 0.15 to about 1.75, from about 0.15 to about 1.5, from about 0.15 to about 1.25, from about 0.15 to about 1, from about 0.15 to about 0.75, from about 0.15 to about 0.55, from about 0.15 to about 0.5, from about 0.2 to about 2, from about 0.2 to about 1.75, from about 0.2 to about 1.5, from about 0.2 to about 1.25, from about 0.2 to about 1, from about 0.2 to about 0.75, from about 0.2 to about 0.55, from about 0.2 to about 0.5, from about 0.25 to about 2, from about 0.25 to about 1.75, from about 0.25 to about 1.5, from about 0.25 to about 1.25, from about 0.25 to about 1, from about 0.25 to about 0.75, from about 0.25 to about 0.55, from about 0.25 to about 0.5, from about 0.3 to about 2, from about 0.3 to about 1.75, from about 0.3 to about 1.5, from about 0.3 to about 1.25, from about 0.3 to about 1, from about 0.3 to about 0.75, from about 0.3 to about 0.55, from about 0.3 to about 0.5, from about 0.35 to about 2, from about 0.35 to about 1.75, from about 0.35 to about 1.5, from about 0.35 to about 1.25, from about 0.35 to about 1, from about 0.35 to about 0.75, from about 0.35 to about 0.55, from about 0.35 to about 0.5, from about 0.4 to about 2, from about 0.4 to about 1.75, from about 0.4 to about 1.5, from about 0.4 to about 1.25, from about 0.4 to about 1, from about 0.4 to about 0.75, from about 0.4 to about 0.55, from about 0.4 to about 0.5, from about 0.45 to about 2, from about 0.45 to about 1.75, from about 0.45 to about 1.5, from about 0.45 to about 1.25, from about 0.45 to about 1, from about 0.45 to about 0.75, from about 0.45 to about 0.55, or from about 0.45 to about 0.5, including any and all ranges and subranges therein.

Unless otherwise indicated herein, the L*, a*, and b* values are measured using a Konica Minolta CM-36dG spectrophotometer using a 25 mm diameter optical glass cuvette.

The cristobalite component of the present disclosure may be made in accordance with making the powder in International Patent Application Serial No.: PCT/US2023/72546, filed Aug. 21, 2023 entitled “REFLECTIVE SILICA BASED GRANULES AND POWDER FOR USE IN ROOFING AND ARCHITECTURAL MATERIALS AND PROCESSES FOR MAKING THE SAME” which has been incorporated by reference herein. Commercially available cristobalite component suitable for inclusion in the coating composition includes, for example, LUMINEX 400, LUMINEX 325, and LUMINEX 14, each available from Covia Solutions LLC.

The coating composition may include greater than or equal to about 10 wt. % cristobalite component, based on a total solids content of the coating composition. For example, the coating composition may include greater than or equal to about 12 wt. %, greater than or equal to about 15 wt. %, greater than or equal to about 20 wt. %, or greater than or equal to about 25 wt. % cristobalite component, based on a total solids content of the coating composition. The coating composition may include cristobalite component in an amount of, for example, from about 10 wt. % to about 35 wt. %, from about 10 wt. % to about 30 wt. %, from about 10 wt. % to about 25 wt. %, from about 10 wt. % to about 20 wt. %, from about 10 wt. % to about 18 wt. %, from about 10 wt. % to about 15 wt. %, from about 12 wt. % to about 35 wt. %, from about 12 wt. % to about 30 wt. %, from about 12 wt. % to about 25 wt. %, from about 12 wt. % to about 20 wt. %, from about 12 wt. % to about 18 wt. %, from about 12 wt. % to about 15 wt. %, from about 15 wt. % to about 35 wt. %, from about 15 wt. % to about 30 wt. %, from about 15 wt. % to about 25 wt. %, from about 15 wt. % to about 20 wt. %, from about 15 wt. % to about 18 wt. %, from about 18 wt. % to about 35 wt. %, from about 18 wt. % to about 30 wt. %, from about 18 wt. % to about 25 wt. %, or from about 18 wt. % to about 20 wt. %, based on a total solids content of the coating composition.

As set forth above, the coating composition further includes clay. The clay generally imparts strength and durability to the coating formed from the composition, and may further offer scrub or abrasion resistance, chemical resistance, brightness, and opacity to the coating. The clay can be, for example, kaolin clay, ball clay, montmorillonite, or combinations thereof. In aspects, the clay is kaolin clay, although other white clays may be including in the coating composition. Commercially available clay suitable for inclusion in the coating composition includes, for example, products sold under the trademark SNOBRITE, including SNOBRITE 75, SNOBRITE 75HB, SNOBRITE 68, and SNOBRITE 60, available from Covia Solutions LLC.

The clay may have median particle size, d50, of less than about 5 μm. For example, the clay may have a d50 of from about 0.1 μm to about 5 μm, from about 0.1 μm to about 4.5 μm, from about 0.1 μm to about 4 μm, from about 0.1 μm to about 3.5 μm, from about 0.1 μm to about 3 μm, from about 0.1 μm to about 2.5 μm, from about 0.1 μm to about 2 μm, from about 0.1 μm to about 1.5 μm, from about 0.1 μm to about 1 μm, from about 0.1 μm to about 0.5 μm, from about 0.1 μm to about 5 μm, from about 0.1 μm to about 4.5 μm, from about 0.1 μm to about 4 μm, from about 0.1 μm to about 3.5 μm, from about 0.1 μm to about 3 μm, from about 0.1 μm to about 2.5 μm, from about 0.1 μm to about 2 μm, from about 0.1 μm to about 1.5 μm, from about 0.1 μm to about 1 μm, from about 0.1 μm to about 0.5 μm, from about 0.2 μm to about 5 μm, from about 0.2 μm to about 4.5 μm, from about 0.2 μm to about 4 μm, from about 0.2 μm to about 3.5 μm, from about 0.2 μm to about 3 μm, from about 0.2 μm to about 2.5 μm, from about 0.2 μm to about 2 μm, from about 0.2 μm to about 1.5 μm, from about 0.2 μm to about 1 μm, from about 0.2 μm to about 0.5 μm, from about 0.4 μm to about 5 μm, from about 0.4 μm to about 4.5 μm, from about 0.4 μm to about 4 μm, from about 0.4 μm to about 3.5 μm, from about 0.4 μm to about 3 μm, from about 0.4 μm to about 2.5 μm, from about 0.4 μm to about 2 μm, from about 0.4 μm to about 1.5 μm, from about 0.4 μm to about 1 μm, or from about 0.4 μm to about 0.5 μm, including any and all ranges and subranges therein.

The clay may be present in the coating composition in an amount of from about 5 wt. % to about 20 wt. %, based on a total solids content of the coating composition. For example, the coating composition may include clay in an amount of from about 5 wt. % to about 20 wt. %, from about 7 wt. % to about 20 wt. %, from about 10 wt. % to about 20 wt. %, from about 12 wt. % to about 20 wt. %, from about 15 wt. % to about 20 wt. %, from about 5 wt. % to about 18 wt. %, from about 7 wt. % to about 18 wt. %, from about 10 wt. % to about 18 wt. %, from about 12 wt. % to about 18 wt. %, from about 15 wt. % to about 18 wt. %, from about 5 wt. % to about 15 wt. %, from about 7 wt. % to about 15 wt. %, from about 10 wt. % to about 15 wt. %, from about 12 wt. % to about 15 wt. %, from about 5 wt. % to about 12 wt. %, from about 7 wt. % to about 12 wt. %, from about 10 wt. % to about 12 wt. %, from about 5 wt. % to about 10 wt. %, from about 7 wt. % to about 10 wt. %, or from about 5 wt. % to about 7 wt. %, based on a total solids content of the coating composition, including any and all ranges and subranges therein.

Titanium dioxide (TiO₂) is also included in the coating composition. The titanium dioxide serves as a reflective pigment, imparting reflectivity and whiteness to the coating formed from the coating composition. In aspects, alternative reflective pigments can be incorporated into the coating composition in place of, or in addition to, the titanium dioxide. Examples of suitable reflective pigments include zinc oxide, zirconium oxide, barium sulfate, titanium calcium, antimony oxide, zinc sulfide, and combinations thereof. The titanium dioxide may be rutile and/or anatase.

Those skilled in the art would be able to select suitable particle sizes of the various titanium dioxide for the coating composition of the present disclosure. For example, a suitable average median particle size for titanium dioxide ranges from about 0.05 μm to about 3 μm, including from about 0.1 μm to about 2 μm, or from about 0.2 μm about 1 μm.

The titanium dioxide present in the coating compositions of the present disclosure ranges from about 10 wt. % to about 35 wt. %, based on a total solids content of the coating composition. For example, the coating composition may include titanium dioxide in an amount of from about 10 wt. % to about 35 wt. %, from about 10 wt. % to about 30 wt. %, from about 10 wt. % to about 25 wt. %, from about 10 wt. % to about 20 wt. %, from about 10 wt. % to about 18 wt. %, from about 10 wt. % to about 15 wt. %, from about 12 wt. % to about 35 wt. %, from about 12 wt. % to about 30 wt. %, from about 12 wt. % to about 25 wt. %, from about 12 wt. % to about 20 wt. %, from about 12 wt. % to about 18 wt. %, from about 12 wt. % to about 15 wt. %, from about 15 wt. % to about 35 wt. %, from about 15 wt. % to about 30 wt. %, from about 15 wt. % to about 25 wt. %, from about 15 wt. % to about 20 wt. %, from about 15 wt. % to about 18 wt. %, from about 18 wt. % to about 35 wt. %, from about 18 wt. % to about 30 wt. %, from about 18 wt. % to about 25 wt. %, or from about 18 wt. % to about 20 wt. %, based on a total solids content of the coating composition, including all ranges and subranges therein.

In various aspects described herein, the titanium dioxide is present in an amount such that a weight ratio of the amount of cristobalite component to the amount of titanium dioxide present in the coating is from about 1:1 to about 5:1. For example, the ratio of the amount of cristobalite component to the amount of titanium dioxide present in the coating may be from about 1:1 to about 5:1, from about 1:1 to about 4.5:1, from about 1:1 to about 4:1, from about 1:1 to about 3.5:1, from about 1:1 to about 3:1, from about 1:1 to about 2.5:1, from about 1:1 to about 2:1, or from about 1:1 to about 1.5:1, including any and all ranges and subranges therein. In aspects described herein, the amount of cristobalite component is greater than the amount of titanium dioxide included in the coating composition.

As set forth above, the coating composition also includes a hardener. The hardener can include any suitable hardener known and used in the art, including alkali and alkaline earth metal compounds such as silicates, oxides, and salts of lithium, sodium, and potassium, as well as oxides and salts of aluminum. Acids and bases which include these elements can also be used, typically dissolved or dispersed in water. In particular, the hardener may be an aqueous sodium silicate solution. The hardener may help to bind the various components of the coating composition together as the coating is dried.

In the present disclosure, the hardener may be included in the coating composition in an amount of from about 15 wt. % to about 65 wt. %. For example, the hardener may be included in an amount of from about 15 wt. % to about 65 wt. %, from about 20 wt. % to about 65 wt. %, from about 25 wt. % to about 65 wt. %, from about 30 wt. % to about 65 wt. %, from about 35 wt. % to about 65 wt. %, from about 40 wt. % to about 65 wt. %, from about 15 wt. % to about 60 wt. %, from about 20 wt. % to about 60 wt. %, from about 25 wt. % to about 60 wt. %, from about 30 wt. % to about 60 wt. %, from about 35 wt. % to about 60 wt. %, from about 40 wt. % to about 60 wt. %, from about 15 wt. % to about 55 wt. %, from about 20 wt. % to about 55 wt. %, from about 25 wt. % to about 55 wt. %, from about 30 wt. % to about 55 wt. %, from about 35 wt. % to about 55 wt. %, from about 40 wt. % to about 55 wt. %, from about 15 wt. % to about 50 wt. %, from about 20 wt. % to about 50 wt. %, from about 25 wt. % to about 50 wt. %, from about 30 wt. % to about 50 wt. %, from about 35 wt. % to about 50 wt. %, or from about 40 wt. % to about 50 wt. %, including any and all ranges and subranges therein.

As described above, the coating composition may be prepared as an aqueous coating composition. In other words, water may be added to the cristobalite component, clay, titanium dioxide, and hardener in an amount sufficient to provide a composition that has a solids content of from about 40 wt. % to about 70 wt. % solids. The cristobalite component, clay, titanium dioxide, hardener, and water are then mixed until evenly dispersed to form the coating composition. It should be understood, however, that the coating composition may be diluted or concentrated to provide a lower or higher amount of solids, depending on the particular application.

### Granules

As described above, the coating composition may be applied to a granule core, dried to form a coating on the granule, and calcined to form a coated granule. The granule core may be nepheline syenite, silica, rhyolite, andesite, dacite, or another mineral aggregate. The core may be crushed or present as a whole grain. Suitable commercially available examples of nepheline syenite include products sold under the tradename MINEX, including MINEX IG-16, available from Covia Solutions LLC.

Depending on the target size for the final, coated granule, the core may have an average particle size of from about 500 μm to about 2,380 μm. For example, the core may have an average particle size of from about 500 μm to about 2,380 μm, from about 500 μm to about 2,000 μm, from about 500 μm to about 1,680 μm, from about 500 μm to about 1,410 μm, from about 500 μm to about 1,190 μm, from about 500 μm to about 1,000 μm, from about 500 μm to about 841 μm, from about 500 μm to about 707 μm, from about 500 μm to about 595 μm, from about 595 μm to about 2,380 μm, from about 595 μm to about 2,000 μm, from about 595 μm to about 1,680 μm, from about 595 μm to about 1,410 μm, from about 595 μm to about 1,190 μm, from about 595 μm to about 1,000 μm, from about 595 μm to about 841 μm, from about 595 μm to about 707 μm, from about 707 μm to about 2,380 μm, from about 707 μm to about 2,000 μm, from about 707 μm to about 1,680 μm, from about 707 μm to about 1,410 μm, from about 707 μm to about 1,190 μm, from about 707 μm to about 1,000 μm, from about 707 μm to about 841 μm, from about 841 μm to about 2,380 μm, from about 841 μm to about 2,000 μm, from about 841 μm to about 1,680 μm, from about 841 μm to about 1,410 μm, from about 841 μm to about 1,190 μm, from about 841 μm to about 1,000 μm, from about 1,000 μm to about 2,380 μm, from about 1,000 μm to about 2,000 μm, from about 1,000 μm to about 1,680 μm, from about 1,000 μm to about 1,410 μm, from about 1,000 μm to about 1,190 μm, from about 1,190 μm to about 2,380 μm, from about 1,190 μm to about 2,000 μm, from about 1,190 μm to about 1,680 μm, from about 1,190 μm to about 1,410 μm, from about 1,410 μm to about 2,380 μm, from about 1,410 μm to about 2,000 μm, from about 1,410 μm to about 1,680 μm, from about 1,680 μm to about 2,380 μm, from about 1,680 μm to about 2,000 μm, or from about 2,000 μm to about 2,380 μm, including any and all ranges and subranges herein.

The size of the core may also be described according to mesh size. For example, the core may be greater than 35 mesh and less than 8 mesh (sometimes denoted −8/±35), such as greater than 35 mesh and less than 10 mesh, greater than 35 mesh and less than 12 mesh, greater than 35 mesh and less than 14 mesh, greater than 35 mesh and less than 16 mesh, greater than 35 mesh and less than 18 mesh, greater than 35 mesh and less than 20 mesh, greater than 35 mesh and less than 25 mesh, greater than 35 mesh and less than 30 mesh, greater than 30 mesh and less than 8 mesh, greater than 30 mesh and less than 10 mesh, greater than 30 mesh and less than 12 mesh, greater than 30 mesh and less than 14 mesh, greater than 30 mesh and less than 16 mesh, greater than 30 mesh and less than 18 mesh, greater than 30 mesh and less than 20 mesh, greater than 30 mesh and less than 25 mesh, greater than 25 mesh and less than 8 mesh, greater than 25 mesh and less than 10 mesh, greater than 25 mesh and less than 12 mesh, greater than 25 mesh and less than 14 mesh, greater than 25 mesh and less than 16 mesh, greater than 25 mesh and less than 18 mesh, greater than 25 mesh and less than 20 mesh, greater than 20 mesh and less than 8 mesh, greater than 20 mesh and less than 10 mesh, greater than 20 mesh and less than 12 mesh, greater than 20 mesh and less than 14 mesh, greater than 20 mesh and less than 16 mesh, or greater than 20 mesh and less than 18 mesh, including any and all ranges and subranges therein.

With an average particle size of from about 500 μm to about 2,380 μm, the granule core may have an L* value of from about 70 to about 75, from about 70 to about 74, from about 70 to about 73, from about 71 to about 75, from about 71 to about 74, from about 71 to about 73, from about 72 to about 75, from about 72 to about 74, or from about 72 to about 73, including any and all ranges and subranges therein. In particular aspects, the granule core may have an L* value of about 72.7. Moreover, in particular aspects, the granule core may be formed from nepheline syenite having an L* value of 72.7, an a* value of 0.44, and a b* value of 5.21.

In aspects, the granule core may exhibit a solar reflectance of from about 0.30 to about 0.75. For example, the granule core may exhibit a solar reflectance of from about 0.30 to about 0.75, from about 0.30 to about 0.70, from about 0.30 to about 0.65, from about 0.30 to about 0.60, from about 0.35 to about 0.75, from about 0.35 to about 0.70, from about 0.35 to about 0.65, from about 0.35 to about 0.60, from about 0.40 to about 0.75, from about 0.40 to about 0.70, from about 0.40 to about 0.65, from about 0.40 to about 0.60, from about 0.45 to about 0.75, from about 0.45 to about 0.70, from about 0.45 to about 0.65, from about 0.45 to about 0.60, from about 0.50 to about 0.75, from about 0.50 to about 0.70, from about 0.50 to about 0.65, from about 0.50 to about 0.60, from about 0.55 to about 0.75, from about 0.55 to about 0.70, from about 0.55 to about 0.65, or from about 0.55 to about 0.60, including any and all ranges and subranges therein. In particular aspects, the granule core may exhibit a solar reflectance of from about 0.54 to about 0.59, from about 0.55 to about 0.58, from about 0.56 to about 0.58, from about 0.57 to about 0.58, or about 0.577. Solar reflectance can be measured, for example, using a solar spectrum reflectometer, such as SSR-ER version 6, available from Devices and Services (Dallas, TX).

The solar spectrum reflectometer measures the solar reflectance of a flat surface positioned at a measurement port having an area of approximately one inch in diameter. To measure granular materials or powder, a petri dish may be used. Other types of dishes may be used, provided that when filled, the material is opaque or nearly opaque. The cell is filled and leveled to the surface, and the SSR measurement head is carefully positioned over the sample such that the sample completely covers the port area and the surface of the granules or powder is flush with the usual position of a solid flat sample.

The coating composition can be applied to the granule core using any one of a variety of suitable coating processes. In various aspects, the granule core (e.g., mineral aggregate) may be preheated and then added to a mixer to which the coating is then added. For example, the granule core may be preheated at a temperature of from about 90° C. to about 130° C. for a time of from about 10 minutes to 20 minutes. The temperature may be, for example, from about 90° C. to about 130° C., from about 95° C. to about 130° C., from about 100° C. to about 130° C., from about 105° C. to about 130° C., from about 110° C. to about 130° C., from about 90° C. to about 125° C., from about 95° C. to about 125° C., from about 100° C. to about 125° C., from about 105° C. to about 125° C., from about 110° C. to about 125° C., from about 90° C. to about 120° C., from about 95° C. to about 120° C., from about 100° C. to about 120° C., from about 105° C. to about 120° C., from about 110° C. to about 120° C., from about 90° C. to about 115° C., from about 95° C. to about 115° C., from about 100° C. to about 115° C., from about 105° C. to about 115° C., from about 110° C. to about 115° C., from about 90° C. to about 110° C., from about 95° C. to about 110° C., from about 100° C. to about 110° C., or from about 105° C. to about 110° C., including any and all ranges and subranges therein. The time for the preheating treatment may be from about 10 minutes to about 20 minutes, from about 12 minutes to about 20 minutes, from about 14 minutes to about 20 minutes, from about 10 minutes to about 18 minutes, from about 12 minutes to about 18 minutes, from about 14 minutes to about 18 minutes, from about 10 minutes to about 16 minutes, from about 12 minutes to about 16 minutes, or from about 14 minutes to about 16 minutes, including any and all ranges and subranges therein. In an exemplary aspect, the granule core may be preheated at about 110° C. for about 15 minutes.

In various aspects, the preheated granule core and coating composition are mixed in a mixer to coat, or substantially coat, the granule cores. The amount of coating composition may vary, and in exemplary aspects, is added to achieve a content of from about 1 wt. % to about 5 wt. % solids (e.g., about 1 wt. %, about 2 wt. %, about 3 wt. %, about 4 wt. %, or about 5 wt. %) compared to the granule core. Once the granule cores are substantially coated with the coating composition, the coated granules are dried and then calcined to form the roofing granules.

The coating may be dried at a temperature of from about 90° C. to about 130° C. for a time of from about 15 minutes to 30 minutes. The temperature may be, for example, from about 90° C. to about 130° C., from about 95° C. to about 130° C., from about 100° C. to about 130° C., from about 105° C. to about 130° C., from about 110° C. to about 130° C., from about 90° C. to about 125° C., from about 95° C. to about 125° C., from about 100° C. to about 125° C., from about 105° C. to about 125° C., from about 110° C. to about 125° C., from about 90° C. to about 120° C., from about 95° C. to about 120° C., from about 100° C. to about 120° C., from about 105° C. to about 120° C., from about 110° C. to about 120° C., from about 90° C. to about 115° C., from about 95° C. to about 115° C., from about 100° C. to about 115° C., from about 105° C. to about 115° C., from about 110° C. to about 115° C., from about 90° C. to about 110° C., from about 95° C. to about 110° C., from about 100° C. to about 110° C., or from about 105° C. to about 110° C., including any and all ranges and subranges therein. The time for drying may be from about 15 minutes to about 30 minutes, from about 18 minutes to about 30 minutes, from about 20 minutes to about 30 minutes, from about 15 minutes to about 28 minutes, from about 18 minutes to about 28 minutes, from about 20 minutes to about 28 minutes, from about 15 minutes to about 26 minutes, from about 18 minutes to about 26 minutes, or from about 18 minutes to about 24 minutes, including any and all ranges and subranges therein. It should be appreciated that the amount of time for drying may vary depending on the selected temperature in various aspects. In one exemplary aspect, the coated granules may be dried at about 110° C. for about 20 minutes.

Calcination of the dried, coated granules can be carried out at a temperature of from about 260° C. to about 550° C. for a time of from about 40 minutes to about 90 minutes. For example, the calcination can be carried out at a temperature of from about 260° C. to about 550° C., from about 300° C. to about 550° C., from about 340° C. to about 550° C., from about 380° C. to about 550° C., from about 420° C. to about 550° C., from about 440° C. to about 550° C., from about 480 to about 550° C., from about 520° C. to about 550° C., from about 260° C. to about 520° C., from about 300° C. to about 520° C., from about 340° C. to about 520° C., from about 380° C. to about 520° C., from about 420° C. to about 520° C., from about 440° C. to about 520° C., from about 480 to about 520° C., from about 260° C. to about 480° C., from about 300° C. to about 480° C., from about 340° C. to about 480° C., from about 380° C. to about 480° C., from about 420° C. to about 480° C., from about 440° C. to about 480° C., from about 260° C. to about 440° C., from about 300° C. to about 440° C., from about 340° C. to about 440° C., from about 380° C. to about 440° C., from about 420° C. to about 440° C., from about 260° C. to about 420° C., from about 300° C. to about 420° C., from about 340° C. to about 420° C., or from about 380° C. to about 420° C., including any and all ranges and subranges therein. The time for calcination of the dried, coated granules can be from about 40 minutes to about 90 minutes, from about 50 minutes to about 90 minutes, from about 60 minutes to about 90 minutes, from about 40 minutes to about 80 minutes, from about 50 minutes to about 80 minutes, from about 60 minutes to about 80 minutes, from about 40 minutes to about 70 minutes, from about 50 minutes to about 70 minutes, or from about 60 minutes to about 70 minutes, including any and all ranges and subranges therein. It should be appreciated that the amount of time for calcination may vary depending on the selected temperature in various aspects. In exemplary aspects, the dried coated granules may be calcined at a temperature of from about 260° C. to about 550° C. for about one hour.

Following calcination, the coated granules may be allowed to cool at ambient conditions. In aspects, additional coating layers may be applied by mixing coated granules with additional coating composition. In aspects, each layer of coating may be dried prior to the application of a subsequent layer of coating composition. In aspects, each layer of coating may be dried and calcined prior to the application of a subsequent layer of coating composition. Accordingly, in any of the aspects herein, the granule core may have one, two, three, four, five, or more layers of coating applied thereon.

In various aspects, the coated granules can be sieved for selection of granules having a particular size. Sieving can be carried out in any suitable method known and used in the art, including but not limited to the use of vibratory screens. In various aspects, the granules are selected to have a particle size based on a −8/±35 mesh. In aspects, the granules have an average particle size of from about 0.45 mm to about 2.5 mm. However, in other aspects, granules having larger or smaller particle sizes can be used, depending on the particular application. For example, when the granules are intended for use in roofing applications (e.g., applied to the surface of a shingle or flat top roof), the granules can be selected to have a standard size #11 granule size or another standard size that is commonly used in the roofing industry. In other applications, such as when the granules will be used as a filler for pigments, coarser or finer granules can be used.

The shape of the coated granules is typically round, although it is contemplated that the agglomeration process described above could be altered to achieve granules having other shapes. In various aspects, the coated granules have an aspect ratio (maximum width:maximum length) of from about 1:1 to about 1:1.4. For example, the coated granules may have an aspect ratio of from about 1:1 to about 1:1.4, from about 1:1 to about 1:1.3, from about 1:1 to about 1:1.2, or from about 1:1 to about 1:1.1, including any and all ranges and subranges therein.

As previously mentioned, the coated granules exhibit an improved solar reflectance of from about 5% to about 18%, as compared to the uncoated granule core. For example, the coated granules may exhibit an improved solar reflectance of from about 5% to about 18%, from about 5% to about 16%, from about 5% to about 12%, from about 5% to about 10%, from about 6% to about 18%, from about 6% to about 16%, from about 6% to about 12%, from about 6% to about 10%, from about 7% to about 18%, from about 7% to about 16%, from about 7% to about 12%, from about 7% to about 10%, from about 8% to about 18%, from about 8% to about 16%, from about 8% to about 12%, from about 8% to about 10%, from about 10% to about 18%, from about 10% to about 16%, or from about 10% to about 12%, including any and all ranges and subranges therein.

As a result of the coating, in various aspects, the coated granules exhibit an L* value on the CIE LAB color scale of greater than about 70. For example, the coated granules may exhibit an L* value of from about 70 to about 90. In various aspects, the coated granules exhibit an improvement in L* of at least 6% as compared to the L* of the uncoated core alone. For example, the coated granules may exhibit an L* value that is at least 6%, at least 7%, at least 8%, at least 9%, at least 10%, at least 11%, or at least 15% greater than the L* value of the uncoated core alone. In aspects, the coated granules may have an L* that is from about 6% to about 25% greater than the L* of the uncoated core, from about 8% to about 25% greater than the L* of the uncoated core, from about 10% to about 25% greater than the L* of the uncoated core, from about 11% to about 25% greater than the L* of the uncoated core, from about 15% to about 25% greater than the L* of the uncoated core, from about 6% to about 20% greater than the L* of the uncoated core, from about 8% to about 20% greater than the L* of the uncoated core, from about 10% to about 20% greater than the L* of the uncoated core, from about 11% to about 20% greater than the L* of the uncoated core, from about 15% to about 20% greater than the L* of the uncoated core, from about 6% to about 18% greater than the L* of the uncoated core, from about 8% to about 18% greater than the L* of the uncoated core, from about 10% to about 18% greater than the L* of the uncoated core, from about 11% to about 18% greater than the L* of the uncoated core, from about 15% to about 18% greater than the L* of the uncoated core, from about 6% to about 15% greater than the L* of the uncoated core, from about 8% to about 15% greater than the L* of the uncoated core, from about 10% to about 15% greater than the L* of the uncoated core, or from about 11% to about 15% greater than the L* of the uncoated core, including any and all ranges and subranges therein.

In any of the aspects disclosed herein, the coated granules may exhibit an a* value of from about −0.1 to about 1.0, or from about 0.2 to about 0.8 when measured on the CIE LAB color scale, including any and all ranges and subranges therein. In any of the aspects disclosed herein, the coated granules may exhibit a b* value of from about 2.0 to about 5.0, or from about 2.5 to about 4.0 when measured on the CIE LAB color scale, including any and all ranges and subranges therein.

The coating composition can also provide improved abrasion resistance, as represented by the amount of fines created, and reported as a percentage of weight of fines created divided by the weight of the sample prior to being subjected to the abrasion process. For example, the coated granules may exhibit an amount of fines created of less than about 1.5 wt. %, based on a total weight of fines produced. The coated granules may exhibit an amount of fines created of less of less than about 1.5 wt. %, less than about 1.4 wt. %, less than about 1.3 wt. %, less than about 1.2 wt. %, less than about 1.1 wt. %, or even less than about 1.0 wt. %. The coated granules may exhibit an abrasion resistance of from about 0.1 wt. % to about 1.5 wt. % fines created, including from about 0.1 wt. % to about 1.4 wt. %, from about 0.1 wt. % to about 1.3 wt. %, from about 0.1 wt. % to about 1.2 wt. %, from about 0.1 wt. % to about 1.1 wt. %, from about 0.1 wt. % to about 1.0 wt. %, from about 0.2 wt. % to about 1.5 wt. %, from about 0.2 wt. % to about 1.4 wt. %, from about 0.2 wt. % to about 1.3 wt. %, from about 0.2 wt. % to about 1.2 wt. %, from about 0.2 wt. % to about 1.1 wt. %, from about 0.2 wt. % to about 1.0 wt. %, from about 0.4 wt. % to about 1.5 wt. %, from about 0.4 wt. % to about 1.4 wt. %, from about 0.4 wt. % to about 1.3 wt. %, from about 0.4 wt. % to about 1.2 wt. %, from about 0.4 wt. % to about 1.1 wt. %, from about 0.4 wt. % to about 1.0 wt. %, from about 0.6 wt. % to about 1.5 wt. %, from about 0.6 wt. % to about 1.4 wt. %, from about 0.6 wt. % to about 1.3 wt. %, from about 0.6 wt. % to about 1.2 wt. %, from about 0.6 wt. % to about 1.1 wt. %, from about 0.6 wt. % to about 1.0 wt. %, from about 0.8 wt. % to about 1.5 wt. %, from about 0.8 wt. % to about 1.4 wt. %, from about 0.8 wt. % to about 1.3 wt. %, from about 0.8 wt. % to about 1.2 wt. %, from about 0.8 wt. % to about 1.1 wt. %, from about 0.8 wt. % to about 1.0 wt. %, from about 1.0 wt. % to about 1.5 wt. %, from about 1.0 wt. % to about 1.4 wt. %, from about 1.0 wt. % to about 1.3 wt. %, or from about 1.0 wt. % to about 1.2 wt. %, including any and all ranges and subranges therein.

In various aspects, the coated granules can be used as granules on roofing shingles. For example, the coated granules can be used as specialty granules on roofing shingles to provide increased solar reflectivity as compared to conventional standard roofing granules.

### EXAMPLES

The following examples are included for the purposes of illustration and do not limit the general inventive concepts described herein.

### Example 1

In the examples, the cristobalite component was added as LUMINEX 400, commercially available from Covia Solutions LLC. The kaolin clay was added as SNOBRITE 75 HB. The hardener, sodium silicate, was added as a 40 wt. % solids aqueous solution. Additional water was added to the coating compositions to provide a coating composition having 50 wt. % solids. Solar reflectivity (SR) values and L* a* b* values for each of the ingredients is provided in Table 1 below.

TABLE 1

| Raw Material | L* | a* | b* | SR |
|---|---|---|---|---|
| Luminex | 97.79 | −0.03 | 0.49 | 0.87 |
| SNOBRITE 75HB | 90.8 | 0.61 | 7.65 | 0.82 |
| Titanium dioxide | 95.62 | −0.82 | 2.77 | 0.86 |
| MINEX IG-16 | 72.7 | 0.44 | 5.21 | 0.56 |

A ladder study was conducted using the base formulae in Table 2. To each formula, an amount of LUMINEX 400 was added, which varied between 0 g and 200 g. The amounts reported in Table 2 are the weight in grams. Water was also added to the compositions to prepare coating compositions having 55 wt % solids.

TABLE 2

| | Formula | Formula | Formula | Formula |
|---|---|---|---|---|
| | A-0 | A-10 | A-30 | B |
| Clay | 42.9 g | 42.9 g | 42.9 g | 8.3 g |
| Sodium Silicate | 57.1 g | 57.1 g | 57.1 g | 91.7 g |
| (40%) | | | | |
| TiO₂ | 0 g | 10 g | 30 g | 50 g |

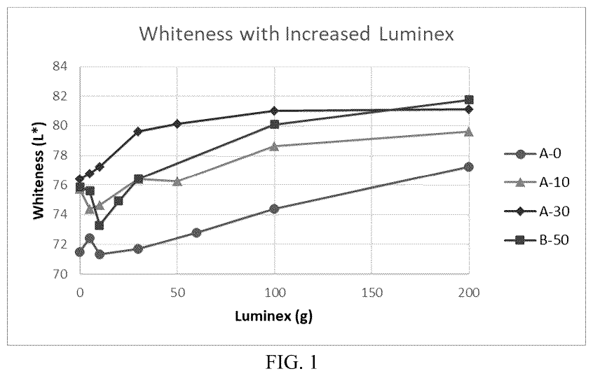

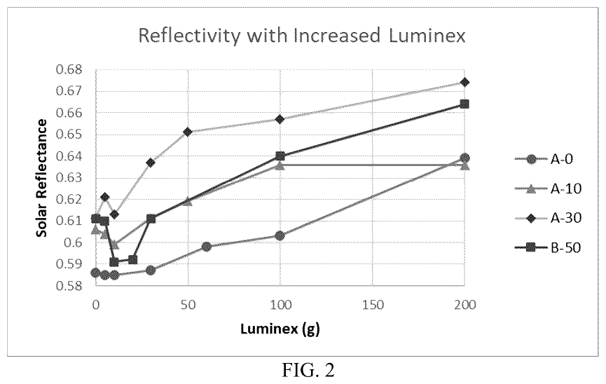

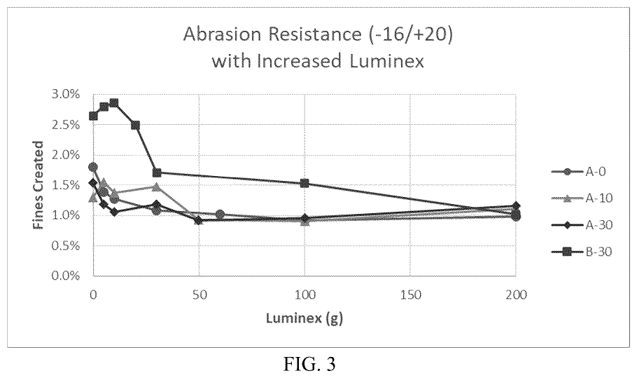

Each of the coating compositions was applied to a MINEX IG-16 core in three coating steps and calcined following application and drying of the third coat, as described above. For each of the coating compositions at various amounts of LUMINEX 400, whiteness (L*), solar reflectance, and abrasion resistance were measured. Solar reflectance was measured in accordance with ASTM C1549 and measured with a D&S Model SSR-ER version 6 solar spectrum reflectometer. Abrasion resistance for uncoated MINEX IG-16 was 0.19%. Abrasion resistance was measured in accordance with the ARMA 1993 method. The results are shown in FIGS. 1-3.

As seen in FIGS. 1-3, the coated granules having the coating that includes a weight ratio of amount of LUMINEX 400 to amount of TiO₂ of from about 1:1 to about 5:1 exhibit increased whiteness (L*) of 6.2-12.4% as compared to the uncoated granule and an increased solar reflectance of from about 6% to about 14% without a substantial increase in the amount of fines created.

Although only a few aspects of this invention have been described above, it should be appreciated that many modifications can be made without departing from the spirit and scope of the invention. All such modifications are intended to be included within this invention, which is to be limited only by the following claims.

1. A roofing granule comprising:
a core; and
a coating on the core, the coating comprising:
at least 10 wt. % of a cristobalite component;
titanium dioxide;
clay; and
a hardener,
wherein the roofing granule exhibits an improvement in L* value of at least 6% as compared to an L* value of the core alone.

2. The roofing granule of claim 1, wherein core comprises nepheline syenite.

3. The roofing granule of claim 1, wherein the coating comprises from about 10 wt. % to about 35 wt. % cristobalite component.

4. The roofing granule of claim 1, wherein the coating comprises from about 10 wt. % to about 35 wt. % titanium dioxide.

5. The roofing granule of claim 1, wherein a weight ratio of the amount of cristobalite component to the amount of titanium dioxide in the coating is from about 1:1 to about 5:1.

6. The roofing granule of claim 1, wherein the titanium dioxide is pigmentary.

7. The roofing granule of claim 1, wherein the coating comprises from about 5 wt. % to about 20 wt. % kaolin clay.

8. The roofing granule of claim 1, wherein the hardener comprises sodium silicate.

9. The roofing granule of claim 1, wherein the roofing granule has an aspect ratio of from about 1:1 to about 1:1.4.

10. The roofing granule of claim 1, wherein the roofing granule exhibits an improvement in solar reflectivity of at least 5% as compared to the solar reflectivity of the core alone.

11. The roofing granule of claim 1, wherein the roofing granule has an average particle size of from about 0.45 mm to about 2.5 mm.

12. A coating composition for a roofing granule, the coating composition comprising
at least 10 wt. % of a cristobalite component;
titanium dioxide;
clay; and
a hardener,
wherein, when applied to a core comprising nepheline syenite and calcined to form a roofing granule, the resulting roofing granule exhibits an improvement in L* value of at least 6% as compared to an L* value of the core alone.

13. The coating composition of claim 12, wherein a weight ratio of the amount of cristobalite component to the amount of titanium dioxide in the coating is from about 1:1 to about 5:1.

14. The coating composition of claim 12, wherein the coating composition comprises from about 10 wt. % to about 35 wt. % cristobalite component.

15. The coating composition of claim 12, wherein the coating composition comprises from about 10 wt. % to about 35 wt. % titanium dioxide.

16. The coating composition of claim 12, wherein the titanium dioxide is pigmentary.

17. The coating composition of claim 12, wherein the coating composition comprises from about 5 wt. % to about 20 wt. % kaolin clay.

18. The coating composition of claim 12, wherein the hardener comprises sodium silicate.

19. A roofing granule comprising:
a core; and
a coating on the core, the coating comprising:
at least 10 wt. % of a cristobalite component;
titanium dioxide;
clay; and
a hardener,
wherein the roofing granule exhibits an improvement in solar reflectivity of at least 5% as compared to a solar reflectivity of the core alone.

20. The roofing granule of claim 19, wherein a weight ratio of the amount of cristobalite component to the amount of titanium dioxide in the coating is from about 1:1 to about 5:1.

21. The roofing granule of claim 19, wherein core comprises nepheline syenite.

22. The roofing granule of claim 19, wherein the coating comprises from about 10 wt. % to about 35 wt. % cristobalite component.

23. The roofing granule of claim 19, wherein the coating comprises from about 10 wt. % to about 35 wt. % titanium dioxide.

24. The roofing granule of claim 19, wherein the titanium dioxide is pigmentary.

25. The roofing granule of claim 19, wherein the coating comprises from about 5 wt. % to about 20 wt. % kaolin clay.

26. The roofing granule of claim 19, wherein the hardener comprises sodium silicate.

27. The roofing granule of claim 19, wherein the roofing granule has an aspect ratio of from about 1:1 to about 1:1.4.

28. The roofing granule of claim 19, wherein the roofing granule exhibits an improvement in solar reflectivity of from 5% to about 18% as compared to the solar reflectivity of the core alone.

29. The roofing granule of claim 19, wherein the roofing granule has an average particle size of from about 0.45 mm to about 2.5 mm.
